(19) United States
(12) Patent Application Publication
(10) Pub. No.: US 2002/0018561 A1
(43) Pub. Date: Feb. 14, 2002

(54) Data encryption and decryption using error correction methodologies

(75) Inventor: Glenn A. Emelko, Concord Township, OH (US)

Correspondence Address: MARK KUSNER COMPANY LPA, HIGHLAND PLACE SUITE 310, 6151 WILSON MILLS ROAD, HIGHLAND HEIGHTS, OH, 44143

(73) Assignee: Vidicast Ltd.

(21) Appl. No.: 09/921,072

(22) Filed: Aug. 2, 2001

Related U.S. Application Data
(60) Provisional application No. 60/222,449, filed on Aug. 2, 2000.

(51) Int. Cl. H04L 9/00

(52) U.S. Cl. 380/28; 713/181

(57) ABSTRACT

A system and method to encrypt and decrypt data into highly secure forms, which uses common error correction hardware or algorithms to encipher data, with little or no impact on system cost or performance. The data encryption/decryption system allows a nearly limitless number of encryption keys to be used without compromising security, rather than encryption methods such as Data Encryption Standard (DES), which rely upon the difficulty in the factorization of keys based upon large prime numbers.

### RELATED APPLICATIONS

The present application claims the benefit of U.S. Provisional Application No. 60/222,449 filed Aug. 2, 2000.

### FIELD OF THE INVENTION

The present invention relates to the field of data encryption and decryption, and more particularly to a data encryption/decryption system which employs error correction methods to encrypt and decrypt data.

### BACKGROUND OF THE INVENTION

There exist many different systems in the prior art to encrypt and decrypt data. Most of these are based upon DES (Data Encryption Standard) algorithms, which have been published by the National Bureau of Standards, and are widespread in their use and implementation. Numerous other methods have been devised, achieving different levels of security [Newman and Pickholtz, 1987;Tanenbaum, 1988]. Acceptance of a standard for data encryption and decryption is determined by a number of factors. The complexity of the method, the additional hardware and software overhead required, the security offered (which is typically determined by the characteristics of the encryption key), and the availability of the algorithm to the public, are all factors that determine the success of a given cryptographic method.

In order to offer a new, cost effective, high security encryption and decryption method, it is desirable that the complexity of the method be modest, and that the hardware and software be either already present in a system or easily added in a cost effective way. The security offered by such a method should be relatively high, using large encryption keys, and the algorithm should be widely available or even published without compromising security.

The present invention addresses drawbacks of prior art data encryption/decryption systems, and provides a system for data encryption and decryption that has the above-noted desirable characteristics.

### SUMMARY OF THE INVENTION

In accordance with a first aspect of the present invention, there is provided a method for encrypting data comprising: establishing a code set having N different elements, where N is greater than or equal to 2; receiving d input data symbols to be encrypted, where d is greater than or equal to 1, each input data symbol is an element of the code set; establishing a cryptographic key including c key symbols, where c is greater than or equal to 1, each key symbol is an element of the code set; combining the d data symbols and the c key symbols to form a sequence of k₁ symbols, where k₁ is greater than or equal to 2; applying an error correction encoder algorithm to the sequence of k₁ symbols, resulting in m₁ symbols of error correction information to be assigned to the sequence, where m₁ is greater than or equal to 1; and wherein the resulting m₁ symbols plus the c key symbols are sufficient to compute the d input data symbols, by applying the inverse error correction algorithm.

In accordance with another aspect of the present invention, there is provided a method for decrypting data comprising the steps of: establishing a code set having N different elements, where N is greater than or equal to 2; receiving m₁ data symbols to be decrypted, where m₁ is greater than or equal to 1, each data symbol is an element of the code set; establishing a cryptographic key having c key symbols, where c is greater than or equal to 1, each key symbol is an element of the code set; combining an empty field of d data placeholders and the c key symbols, along with the m₁ encrypted data symbols to form a sequence of n symbols, where d is greater than or equal to 1 and n is greater than or equal to 3, and where the resulting sequence is in the form of a data block with an error correction field that contains d errors specifically known to be in the placeholders; and applying an error correction decoder algorithm to the sequence of n symbols, resulting in d symbols being corrected in the placeholder locations, wherein the resulting d symbols are the decrypted data.

According to still another aspect of the present invention, there is provided a system for encrypting data comprising: means for establishing a code set having N different elements, where N is greater than or equal to 2; means for receiving d input data symbols to be encrypted, where d is greater than or equal to 1, each input data symbol is an element of the code set; means for establishing a cryptographic key including c key symbols, where c is greater than or equal to 1, each key symbol is an element of the code set; means for combining the d data symbols and the c key symbols to form a sequence of k₁ symbols, where k₁ is greater than or equal to 2;encoding means for applying an error correction encoder algorithm to the sequence of k₁ symbols, resulting in m₁ symbols of error correction information to be assigned to the sequence, where m₁ is greater than or equal to 1; and wherein the resulting m₁ symbols plus the c key symbols are sufficient to compute the d input data symbols, by applying the inverse error correction algorithm.

According to still another aspect of the present invention, there is provided a system for decrypting data comprising: means for establishing a code set having N different elements, where N is greater than or equal to 2; means for receiving m₁ data symbols to be decrypted, where m₁ is greater than or equal to 1, each data symbol is an element of the code set; means for establishing a cryptographic key having c key symbols, where c is greater than or equal to 1, each key symbol is an element of the code set; means for combining an empty field of d data placeholders and the c key symbols, along with the m₁ encrypted data symbols to form a sequence of n symbols, where d is greater than or equal to 1, and n is greater than or equal to 3,and where the resulting sequence is in the form of a data block with an error correction field that contains d errors specifically known to be in the placeholders; and encoding means for applying an error correction decoder algorithm to the sequence of n symbols, resulting in d symbols being corrected in the placeholder locations, wherein the resulting d symbols are the decrypted data.

According to yet another aspect of the present invention, there is provided a method for encrypting data comprising the steps of: receiving input data symbols to be encrypted; establishing a cryptographic key; and applying an error correction encoder algorithm to the input data symbols and the cryptographic key, wherein the resulting error correction symbols plus the cryptographic key are sufficient to determine the input data symbols by application an error correction decoder algorithm.

According to yet another aspect of the present invention, there is provided a method for decrypting data comprising the steps of: receiving data symbols to be decrypted; establishing a cryptographic key; and applying an error correction decoder algorithm to the data symbols and cryptographic key to generate decrypted data.

An advantage of the present invention is the provision of a system and method for data encryption/decryption that uses the presence of error correction technology to encrypt data prior to transmission.

Another advantage of the present invention is the provision of a system and method for data encryption/decryption that uses the presence of error correction technology to decrypt data after reception.

Another advantage of the present invention is the provision of a system and method for data encryption/decryption which is cost effective to implement.

Still another advantage of the present invention is the provision of a system and method for data encryption/decryption which provides high security.

Still another advantage of the present invention is the provision of a system and method for data encryption/decryption which minimizes complexity.

Yet another advantage of the present invention is the provision of a system and method for data encryption/decryption which can be implemented using existing or easily obtainable hardware and software.

Yet another advantage of the present invention is the provision of a system and method for data encryption/decryption which is suitable for use with large encryption keys.

Yet another advantage of the present invention is the provision of a system and method for data encryption/decryption which employs an algorithm that is widely available, or is published, without compromising security.

Still other advantages of the invention will become apparent to those skilled in the art upon a reading and understanding of the following detailed description, accompanying drawings and appended claims.

### BRIEF DESCRIPTION OF THE DRAWINGS

The above-mentioned and other features and objects of the invention and the manner of attaining them will become more apparent and the invention will be best understood by reference to the following description of an embodiment of the invention taken in conjunction with the accompanying drawings and appended claims, wherein:

FIG. 1 is an example of the normal intended use for a Reed-Solomon codec.

FIG. 2 is an example of a Reed-Solomon block of n elements being formed by appending k data elements with m ECC elements to form a block k+m in length.

FIG. 3 is an example of a received block having eight erasures and three symbol errors, indicated respectively with R and S in the example. As long as 2S+R=m then the received block can be corrected completely back into the original form shown in FIG. 2.

FIG. 4a and FIG. 4b are exemplary flow diagrams of the method of the present invention, in accordance with a preferred embodiment.

FIG. 5 is a typical encryption block, which is created for the purpose of carrying out the Data Encryption step shown in FIGS. 4a and 4b.

FIG. 6 is a typical decryption block, which is created for the purpose of carrying out the Data Decryption step shown in FIGS. 4a and 4b.

### DETAILED DESCRIPTION OF THE PREFERRED EMBODIMENT

In summary, the present invention uses error correction methods to encrypt data into a secure format. The error correction methods include, but are not limited to: block codes, FEC (Forward Error Correction), ECC (Error Correction Codes), BCH (Bose-Chaudhuri-Hocqenghem), Golay, and Reed-Solomon Algorithms. These codes are modest in their complexity, and hardware and software are readily available to implement the use of such codes in data transmission and reception systems. In fact, error correction methods are widely used to ensure the integrity of the transmission itself, allowing the recovery of a corrupt data transmission and restoring the data to its original form. Thus, in many communications systems in widespread use today, error correction codecs are already present, typically implemented in either hardware or software, or a combination of both.

The presence of error correction technology is used to encrypt data prior to transmission, and used to decrypt data after reception. It should understood that in accordance with a preferred embodiment, an error correction encoder and decoder are used during the data transmission and reception phase for maintaining the integrity of the data transmission itself. In accordance with one embodiment of the present invention, the unencrypted data is preprocessed, prior to transmission, by applying an error correction encoder to create an encrypted data stream. This encrypted data stream is then sent in a reliable manor, using the error correction encoder in its usual form, to a receiver. At the receiving end, the data is extracted and error corrected by applying an error correction decoder (which applies the inverse error correction algorithm). After error correction, the received encrypted data is passed back through the error correction decoder to decrypt it back into its original, unencrypted form.

It should be appreciated that it is not necessary that the error correction codec that is used for the encryption and decryption process be related to the form of data transmission and/or any error correction applied to that transmission. However, it should be noted that the presence of an existing error correction engine may make it cost effective to dual purpose it's use for encrypting and decrypting data.

In another embodiment of the present invention, the use of error correction hardware or software as a method of encryption and decryption can be applied to secure data in-place, such as encrypted files on a diskette, hard drive, or other storage or transmission media, or for myriad other purposes.

In accordance with a preferred embodiment of the present invention, there is provided an error correction codec, such as a Reed-Solomon codec. It should be appreciated that while a preferred embodiment of the present invention is described in connection with the Reed-Solomon codec, this is not intended to limited same. In this regard other error correction codecs are also suitably used in connection with the present invention.

A Reed-Solomon codec will now be briefly described. In this regard, a Reed-Solomon codec allows a block of k elements to be processed as a data block, and an additional m elements are appended to this block, in order to form a total of n elements in a message. The elements themselves may be bits, nibbles, bytes, words, or in more general terms any individual symbol from a set of N different symbols. For a given alphabet or code set of size N (e.g., the numbers from 0 to 999 form a set of 1000 symbols, and 435 is one individual symbol or element of that set), the maximum message length a is bounded to be less than or equal to N−1 elements.

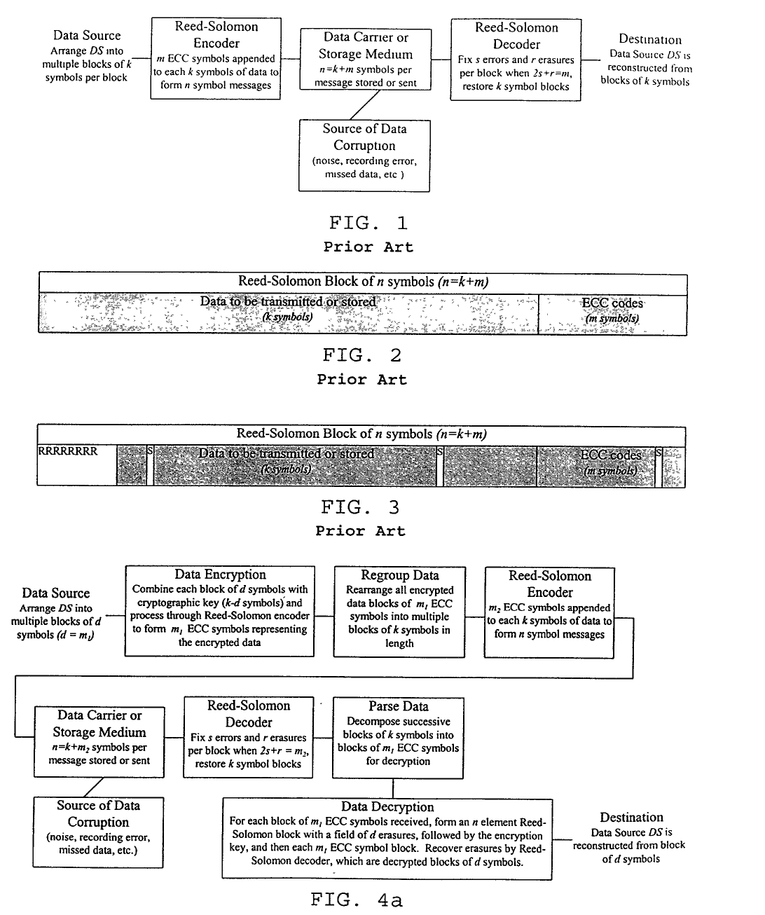

In the typical use of a Reed-Solomon error correction codec, a data block having k elements is Reed-Solomon encoded into a message of n elements, by appending m elements of error correction information (FIG. 2). The entire message of n elements is either stored or transmitted for later use. Upon retrieval or receipt of the message, all n elements are processed through a Reed-Solomon decoder, and if errors have been received that lie within the error correction capability of the code, then they will be corrected and the original k elements will be restored to their correct original form. In the case of a Reed-Solomon codec, the error correction capability is typically expressed in terms of m.

It should be understood that with Reed-Solomon it is possible to recover from two types of errors. First, symbol errors can occur at random anywhere within the message. Second, erasures of specific symbols can be detected by the demodulation system. The Reed-Solomon error correction method can correct up to s symbol errors (i.e., random-position errors) and r erasures (i.e. position-known errors), as long as the total of 2*s+r is less than or equal to m. FIG. 3 illustrates an exemplary data block having both symbol errors and erasures.

In accordance with one embodiment of the present invention, the block of k elements are formed by appending d unencrypted data elements with a cipher key of k−d elements, where d is less than or equal to m. When the error correction encoder processes this special block of k elements, m error correction elements are created to form a message that is n elements in length. These m elements (i.e., the ECC codes) represent an encrypted form of the original data, and it is therefore only necessary to then transmit the m error correction elements to a receiver that knows the cipher key. These m elements may be sent via any normal means, or stored, and otherwise treated as normal data, and exactly represent the original data in an encrypted form, but only have meaning to someone who holds the cipher key and, of course, the error correction algorithm.

In the case where d is equal to m, there is a one-to-one correlation between the length of the unencrypted data and the length of the encrypted data. The receiver, to recover the original data, will form a deciphering block of n elements having d empty placeholders, followed by the cipher key of k−d elements, followed by the m error correction elements which have been received. The receiver processes the deciphering block of n elements through the error correction decoder, determining that there are d errors at the beginning of the deciphering block, and restoring the original d data elements back into place within the d empty placeholders, thereby decrypting the original data transmission.

It should be understood that the position of the d elements within the k element data portion of the message can be varied or even dynamically changed, as long as the encryption and decryption schemes both know where these d elements are placed. In an alternative embodiment of the present invention, the actual position of the d unencrypted data elements is not predetermined. In this case, the restriction is that d must be less than or equal to m/2, which therefore necessarily adds a 50% overhead to the secure transmission of the unencrypted data when it is in its encrypted form.

As indicated above, other error correction codes can be used in similar ways to the Reed-Solomon example given above, as long as the unencrypted data field can be restored within the error correction capability of the algorithm.

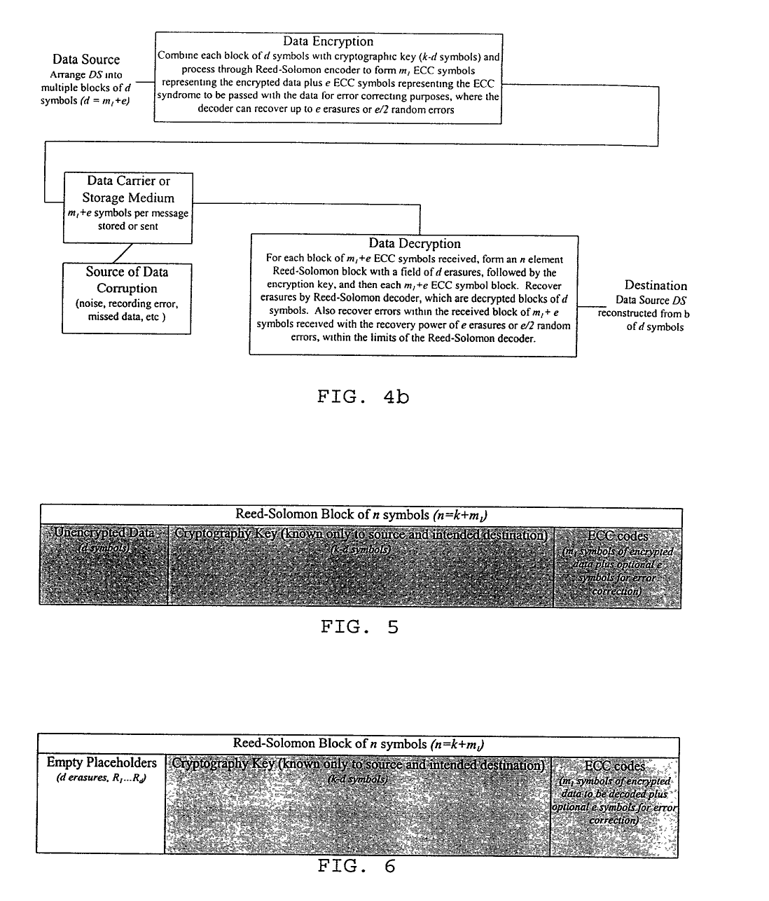

A preferred embodiment of the present invention will now be described in detail with reference to FIG. 4a. A Data Source DS is desired to be transmitted securely to a specific destination (or multiple destinations). Both the Data Source and the Destination have an agreed upon Cryptographic (or Cipher) Key, which is preferably private. The original unencrypted data is broken into multiple blocks of d symbols per block at the Data Source. Each of these blocks is then processed by a Data Encryption step, by combining it with the Cryptographic Key (FIG. 5), and processing it through a Reed-Solomon encoder, in order to form an encrypted form of the data, in its entirety, comprised of m₁ symbols in the ECC field (the syndrome) of the Reed-Solomon block. The entire Data Source DS is processed in this manner, resulting in an encrypted form of DS being formed which can now be sent or stored securely. The encrypted data (i.e., the plurality of m₁ ECC symbols) is now regrouped into multiple blocks of k symbols, which is passed through the Reed-Solomon encoder to form m₂ ECC symbols. These m₂ ECC symbols are appended to the blocks of k symbols (comprised of a plurality of m₁ ECC symbols) to form n=k+m₂ symbols per message. A data carrier transmits the n symbols per message, or a storage medium stores the n symbols per message for later retrieval.

In accordance with the decryption process, a Reed-Solomon Decoder is used to correct errors and/or erasures in the k symbol blocks of the received n symbol data blocks. Thereafter, the n symbol data blocks are parsed to decompose the k symbol blocks into blocks of m₁ ECC symbols (which represent the encrypted data). For each block of m₁ ECC symbols received, an n element Reed-Solomon block is formed with a field of d erasures (representing the decrypted data), followed by the encryption key, and each m₁ ECC symbol block (FIG. 6). The d erasures are recovered using a Reed-Solomon decoder.

In accordance with an alternative embodiment of the present invention, an additional e ECC field bytes are provide in addition to the m₁ ECC field bytes, wherein the e ECC field bytes are allocated solely for the purpose of providing error correction (FIG. 4b). The e ECC field bytes have the same error correcting power as when allocated in a separate ECC pass, allowing encryption and error correction to be both accomplished in a single pass through the Reed-Solomon encoder, with a recovery potential of e erasures or e/2 random errors within the encrypted field itself.

With reference to FIG. 4b, d symbols (i.e., the unencrypted data) and k−d cipher key symbols are combined (FIG. 5), and run through a Reed-Solomon encoder to form m₁ ECC symbols+e ECC symbols, where the m₁ ECC symbols represent the encrypted data, and the e ECC symbols provide error correction of the m₁ ECC symbols. It should be understood that for data transmission the m₁ ECC+e ECC symbols are sent in native form, and do not need to be grouped. The m₁+e symbols may be transmitted via a data carrier or stored to a storage medium for later retrieval.

Upon reception, a parse data step is entered, where the n symbol messages are broken up into individual blocks of m₁+e symbols. At the data decryption step, each parsed block of m₁+e symbols is inserted into a Reed-Solomon decoding block in the ECC field, along with the Cryptographic Key, and an Empty Placeholder, which is marked as a set of d erasures for the Reed-Solomon Decoder (FIG. 6). The Reed-Solomon Decoder will process this block and restore the erasure field completely, since its size is predetermined to be within the error correction capability of the codec. The result is that the original, unencrypted data appears as d symbols in the Empty Placeholder field. Last, the blocks of d symbols are appended to form the original, unencrypted Data Source at the desired destination(s). It should be appreciated that the e ECC symbols are sufficient to correct any errors arising in the m₁ ECC and e ECC symbols.

It should be appreciated that while FIGS. 5 and 6 illustrate an embodiment wherein unencrypted data has been “appended” to the cryptographic key, the unencrypted data may also be “substituted” for selected bytes of the cryptographic key. In this regard, unencrypted data bytes may be appended to the cipher key data bytes, or may be selectively substituted for cipher key data bytes. Moreover, appending and substitution may be used in combination. The location of the unencrypted data field within the Reed-Solomon block is arbitrary, as long as both the encoding location and the decoding location either (a) know the “append” and/or “substitute” locations (erasures) on a block-by-block basis ahead of time, or (b) use some coded information to determine those locations, or (c) are willing to allow overhead for the error correction codes to locate the unknown position of some or all of the random “errors” (which represent the data which is to be encoded). In the latter case, the transmission overhead may be as much as 2:1 or more, however the enhanced security provided by such randomization may be well worth it. It should also be appreciated that this form of transmission allows for public key encryption, where part or all of the cryptographic key is sent via a public carrier in an unsecured transmission, and then the data itself is coded and transferred in coded form. Knowledge of only part of the key and/or only part of the parsing method alone is not necessarily sufficient to allow for easy decoding of the encrypted messages. In any case, the recovery of the original unencrypted data will require the recovery of an erasure.

The present invention can be physically implemented in a variety of ways. In this regard, it may be implemented entirely in software, and executed by a microprocessor or a digital signal processing (DSP) chip. It may be partially or fully implemented by using programmable logic devices, Field Programmable Gate Arrays (FPGAs) or Complex Programmable Logic Devices (CPLDs), such as in the Altera Flex 6K or 10K devices. Error Correction Code (ECC) cores are widely available for these devices. Alternatively, the present invention may be entirely implemented in hardware. For instance, an Application Specific Integrated Circuit (ASIC) or an Advanced Hardware Architectures AHA4013 Reed-Solomon Codec are suitable. It should be fully appreciated that the methods described herein may be suitably applied to those error correction implementations in order to successfully realize a cryptographic system.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof. Furthermore, it should be readily appreciated that the present invention has myriad applications, in all forms of data transmission and data storage, where data encryption/decryption and/or security is desirable.

Having thus described the invention, I claim:

1. A method for encrypting data comprising:
establishing a code set having N different elements, where N is greater than or equal to 2;
receiving d input data symbols to be encrypted, where d is greater than or equal to 1, each input data symbol is an element of the code set;
establishing a cryptographic key including c key symbols, where c is greater than or equal to 1, each key symbol is an element of the code set;
combining the d data symbols and the c key symbols to form a sequence of k₁ symbols, where k₁ is greater than or equal to 2;
applying an error correction encoder algorithm to the sequence of k₁ symbols, resulting in m₁ symbols of error correction information to be assigned to the sequence, where m₁ is greater than or equal to 1; and
wherein the resulting m₁ symbols plus the c key symbols are sufficient to compute the d input data symbols, by applying the inverse error correction algorithm.

2. A method according to claim 1, wherein said method further comprises:
combining the m₁ symbols of error correction information to form a sequence of k₂ symbols, where k₂ is greater than or equal to 2; and
applying an error correction encoder algorithm to the sequence of k₂ symbols, resulting in m₂ symbols of error correction information to be assigned to the sequence, where m₂ is greater than or equal to 1,
wherein said sequence of k₂ symbols comprised of m₁ symbols of error correction information, and the m₂ symbols of error correction information are received for data decryption.

3. A method according to claim 2, wherein said m₂ symbols of error correction information are generated to provide error correction for the m₁ symbols of error correction information.

4. A method according claim 1, wherein said error correction encoder algorithm includes at least one of: block codes, FEC (Forward Error Correction), ECC (Error Correction Codes), BCH (Bose-Chaudhuri-Hocqenghem), Golay, and Reed-Solomon.

5. A method according to claim 1, wherein said m₁ symbols of error correction are sufficient to error correct the d data symbols and m₁ symbols of error correction.

6. A method for decrypting data comprising:
establishing a code set having N different elements, where N is greater than or equal to 2;
receiving m₁ data symbols to be decrypted, where m₁ is greater than or equal to 1, each data symbol is an element of the code set;
establishing a cryptographic key having c key symbols, where c is greater than or equal to 1, each key symbol is an element of the code set;
combining an empty field of d data placeholders and the c key symbols, along with the m₁ encrypted data symbols to form a sequence of n symbols, where d is greater than or equal to 1 and n is greater than or equal to 3, and where the resulting sequence is in the form of a data block with an error correction field that contains d errors specifically known to be in the placeholders; and
applying an error correction decoder algorithm to the sequence of n symbols, resulting in d symbols being corrected in the placeholder locations,
wherein the resulting d symbols are the decrypted data.

7. A method according to claim 6, wherein said m₁ data symbols are error corrected using m₂ data symbols of error correction, where m₂ is greater than or equal to 1, each data symbol is an element of the code set.

8. A method according to claim 6, wherein e data symbols of error correction are received, said e data symbols of error correction are sufficient to correct errors in the m₁ data symbols.

9. A method according claim 6, wherein said error correction decoder algorithm includes at least one of: block codes, FEC (Forward Error Correction), ECC (Error Correction Codes), BCH (Bose-Chaudhuri-Hocqenghem), Golay, and Reed-Solomon.

10. A system for encrypting data comprising:
means for establishing a code set having N different elements, where N is greater than or equal to 2;
means for receiving d input data symbols to be encrypted, where d is greater than or equal to 1, each input data symbol is an element of the code set;
means for establishing a cryptographic key including c key symbols, where c is greater than or equal to 1, each key symbol is an element of the code set;
means for combining the d data symbols and the c key symbols to form a sequence of k₁ symbols, where k₁ is greater than or equal to 2;
encoding means for applying an error correction encoder algorithm to the sequence of k₁ symbols, resulting in m₁ symbols of error correction information to be assigned to the sequence, where m₁ is greater than or equal to 1; and
wherein the resulting m₁ symbols plus the c key symbols are sufficient to compute the d input data symbols, by applying the inverse error correction algorithm.

11. A system according to claim 10, wherein said system further comprises:
means for combining the m₁ symbols of error correction information to form a sequence of k₂ symbols, where k₂ is greater than or equal to 2,said encoding means applying an error correction encoder algorithm to the sequence of k₂ symbols, resulting in m₂ symbols of error correction information to be assigned to the sequence, where m₂ is greater than or equal to 1,
wherein said sequence of k₂ symbols comprised of m₁ symbols of error correction information, and the m₂ symbols of error correction information are received for data decryption.

12. A system according to claim 11, wherein said m₂ symbols of error correction information are generated to provide error correction for the m₁ symbols of error correction information.

13. A system according claim 10, wherein said error correction encoder algorithm includes at least one of: block codes, FEC (Forward Error Correction), ECC (Error Correction Codes), BCH (Bose-Chaudhuri-Hocqenghem), Golay, and Reed-Solomon.

14. A system according to claim 10, wherein said m₁ symbols of error correction are sufficient to error correct the d data symbols and m₁ symbols of error correction.

15. A system for decrypting data comprising:
means for establishing a code set having N different elements, where N is greater than or equal to 2;
means for receiving m₁ data symbols to be decrypted, where m₁ is greater than or equal to 1, each data symbol is an element of the code set;
means for establishing a cryptographic key having c key symbols, where c is greater than or equal to 1, each key symbol is an element of the code set;
means for combining an empty field of d data placeholders and the c key symbols, along with the m1 encrypted data symbols to form a sequence of n symbols, where d is greater than or equal to 1, and n is greater than or equal to 3, and where the resulting sequence is in the form of a data block with an error correction field that contains d errors specifically known to be in the placeholders; and
encoding means for applying an error correction decoder algorithm to the sequence of n symbols, resulting in d symbols being corrected in the placeholder locations,
wherein the resulting d symbols are the decrypted data.

16. A system according to claim 15, wherein said m₁ data symbols are error corrected using m₂ data symbols of error correction, where m₂ is greater than or equal to 1, each data symbol is an element of the code set.

17. A system according to claim 15, wherein e data symbols of error correction are received, said e data symbols of error correction are sufficient to correct errors in the m₁ data symbols.

18. A system according claim 15, wherein said error correction decoder algorithm includes at least one of: block codes, FEC (Forward Error Correction), ECC (Error Correction Codes), BCH (Bose-Chaudhuri-Hocqenghem), Golay, and Reed-Solomon.

19. A method for encrypting data comprising:
receiving input data symbols to be encrypted;
establishing a cryptographic key; and
applying an error correction encoder algorithm to the input data symbols and the cryptographic key, wherein the resulting error correction symbols plus the cryptographic key are sufficient to determine the input data symbols by application of an error correction decoder algorithm.

20. A method for decrypting data comprising:
receiving data symbols to be decrypted;
establishing a cryptographic key; and
applying an error correction decoder algorithm to the data symbols and cryptographic key to generate decrypted data.
